(19) United States
(12) Patent Application Publication
(10) Pub. No.: US 2007/0136091 A1
(43) Pub. Date: Jun. 14, 2007

(54) Method and system for patient transfers and referrals

(76) Inventor: Ryan McTaggart, San Francisco, CA (US)

Correspondence Address: Ryan McTaggart, 4 Nathaniel road, Barrington, RI, 02806-3626, US

(21) Appl. No.: 11/302,720

(22) Filed: Dec. 13, 2005

(51) Int. Cl. G06Q 10/00; H04M 3/51

(52) U.S. Cl. 705/2; 705/11

(57) ABSTRACT

Techniques for patient transfers and referrals are disclosed, including generating a request for the referral and the transfer, the request including information identifying one or more specialists and one or more medical transportation service providers, sending the request for the referral and the transfer to the one or more specialists and the one or more medical transportation service providers via a network, receiving a response from the one or more specialists and the one or more medical transportation service providers identified in the request, the response being used to select the one or more specialists and the one or more medical transportation service providers for awarding of the referral and the transfer, and notifying a selected specialist and a selected medical transportation service to receive the referral and the transfer, the selected specialist and the selected medical transportation service being determined based on information included in the response.

### FIELD OF THE INVENTION

The present invention relates to medical business systems, and more specifically to patient transfer and referral systems.

### BACKGROUND

Several thousand patients may be transferred from one health care facility to another health care facility each day. For these transfers to occur the originating physician may have to spend hours on the phone. For example, the physician may call his triage department to find the phone number for a particular specialist or facility. Next, the physician may call the specialist/facility to discuss the patient case. Afterwards, the specialist may direct the physician to the admissions or transfer center of the facility. Once directed, the physician may call the transfer center to provide patient case information. Finally, the transfer center may get back to the specialist or to the originating physician regarding further details of the case. Ultimately, a decision may be made to accept or decline the patient.

In some conventional scenarios, the phone is answered each time by a person in each step of the process and the patient is accepted. In other conventional scenarios, the physician leaves messages in one or more steps of the process and the patient is refused. In either situation, several hours may be wasted while attempting to affect a transfer. In the case where the patient is refused the physician must start the whole process over again. In the case where the patient is accepted, the physician may have to start the process over again to find appropriate transportation services to physically transport the patient.

Conventional referral processes and techniques are problematic for several reasons. First, there is no degree of certainty that a facility or specialist will accept a patient and no accountability if a facility refuses a patient inappropriately (a violation of the 1986 Emergency Medical Treatment and Active Labor Act). Second, there is no convenient way to transfer medical records and/or referral data. Third, each specialist is contacted individually. Fourth, communication regarding patient needs is commonly handled over the phone, consuming valuable doctoring time (time a doctor spend seeing patients) and valuable injury response time (time that has elapsed between the time of injury/condition and the time of treatment). Fifth, it may take up to 24 hours to transfer a patient, however, many injuries or conditions require treatment within 1-3 hours. Sixth, when the patient is finally transferred, little information is transferred with the patient often causing further delays in treatment. Some conventional solutions provide electronic data and communication platforms for effecting patient referrals, but are confined to usage within a single health care facility or system. Further, due to different or proprietary data standards, conventional platforms provided by different vendors are unable to exchange data, preventing effective communication and relay of information that may be necessary for a patient referral, which may also have severe, if not fatal, effects upon the condition of the patient.

Thus, a solution is needed to improve the patient referral and transfer process without the limitations of conventional techniques and processes.

### BRIEF DESCRIPTION OF THE DRAWINGS

The present invention will be readily understood by the following detailed description in conjunction with the accompanying drawings. In the drawings like reference numerals designate like structural elements.

FIG. 1A is an exemplary representation of a referral and transfer management system.

FIG. 1B is an exemplary representation of the components of a referral and transfer management system.

FIG. 1C is an exemplary representation of a referring provider properties screen.

FIG. 1D is an exemplary representation of a specialist properties screen.

FIG. 1E is an exemplary representation of a medical transportation service properties screen.

FIG. 1F is an exemplary representation of a tracking history for a member.

FIG. 2A is an exemplary representation of a method of patient referral and transfer.

FIG. 2B is an exemplary representation of a general information screen.

FIG. 2C is an exemplary representation of a referral and transfer information screen.

FIG. 3A is an exemplary representation of a method of referral and transfer review.

FIG. 3B is an exemplary representation of provider to specialist/medical transportation services provider communication

FIG. 4A is an exemplary representation of a method of referral and transfer fulfillment.

FIG. 4B is an exemplary representation of a method of referral and transfer fulfillment.

FIG. 5 is a block diagram illustrating an exemplary computer system suitable for managing a referral and a transfer, in accordance with an embodiment

### DETAILED DESCRIPTION

The invention may be implemented in numerous ways, including as a system, a process, an apparatus, or as computer program instructions included on a computer readable medium such as a computer readable storage medium or a computer network wherein program instructions are sent over optical or electronic communication links.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

In some embodiments, a method for patient referral and/or transfer may include generating a request for the referral and transfer, sending the request for the referral and transfer to the one or more specialists and the one or more medical transportation service providers via a network, receiving a response from the one or more specialists and the one or more medical transportation service providers identified in the request, the response being used to select the one or more specialists and the one or more medical transportation service providers for awarding of the referral and transfer, and notifying a selected specialist and a selected medical transportation service to receive the referral and the transfer, the selected specialist and the selected medical transportation service being determined based on information included in the response and the efficiency with which they respond.

In some embodiments, a system for managing patient referral and transfer may include a membership module configured to electronically store member properties and services, wherein the membership includes a plurality of referring providers, a plurality of specialists, and a plurality of medical transportation service providers, a request module configured to originate a referral and transfer request, a notification module configured to notify members of referrals, and a response module configured to accept or deny referrals.

It should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

In this disclosure an organization may refer to a health care network, a medical transportation services provider, a hospital network, or an insurance company. A transfer or referral is a request from one physician to another physician to transfer a patient under their care to another provider or facility; the facilities may or may not be in the same health care network. An external referral is a referral to transfer the patient from one organization to another organization. An internal referral is a transfer or referral of a patient within a closed or community wide health care network (e.g. Kaiser).

Exchange of patient information is also disclosed. Technology and processes that protect patient privacy may be used to comply with Health Insurance Portability and Accountability Act of 1996 (HIPAA) although these processes and technologies are not specifically discussed.

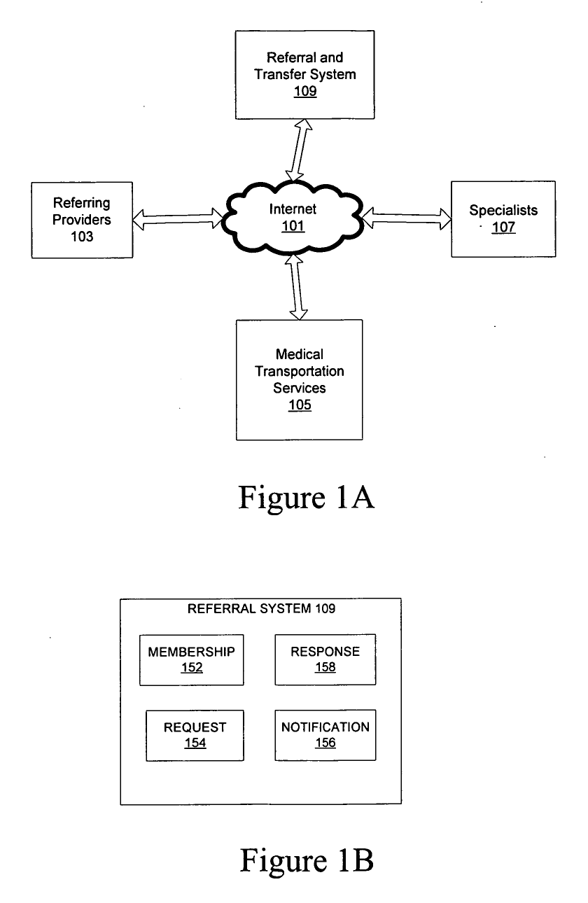

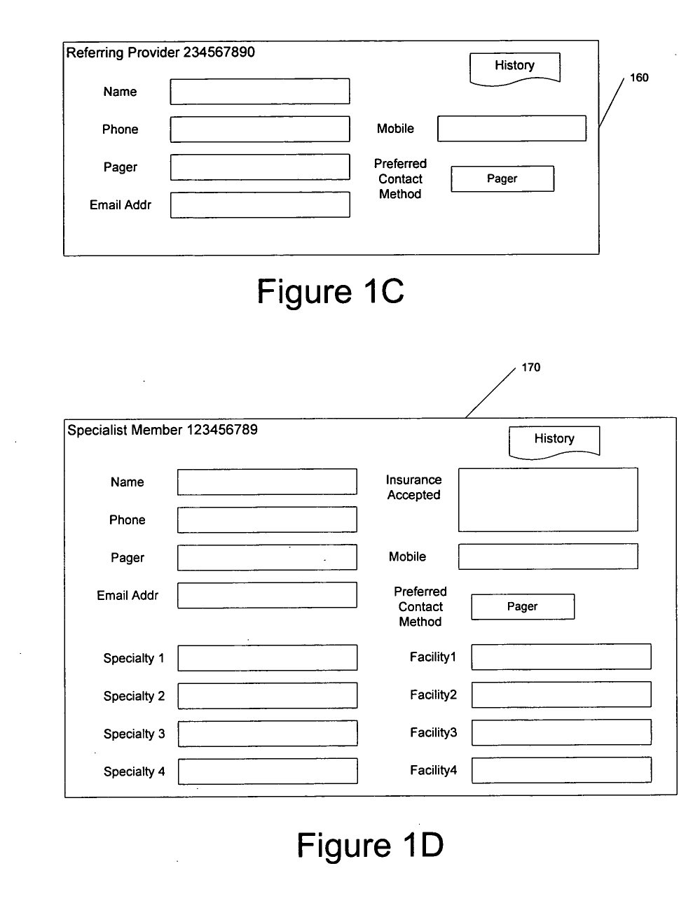

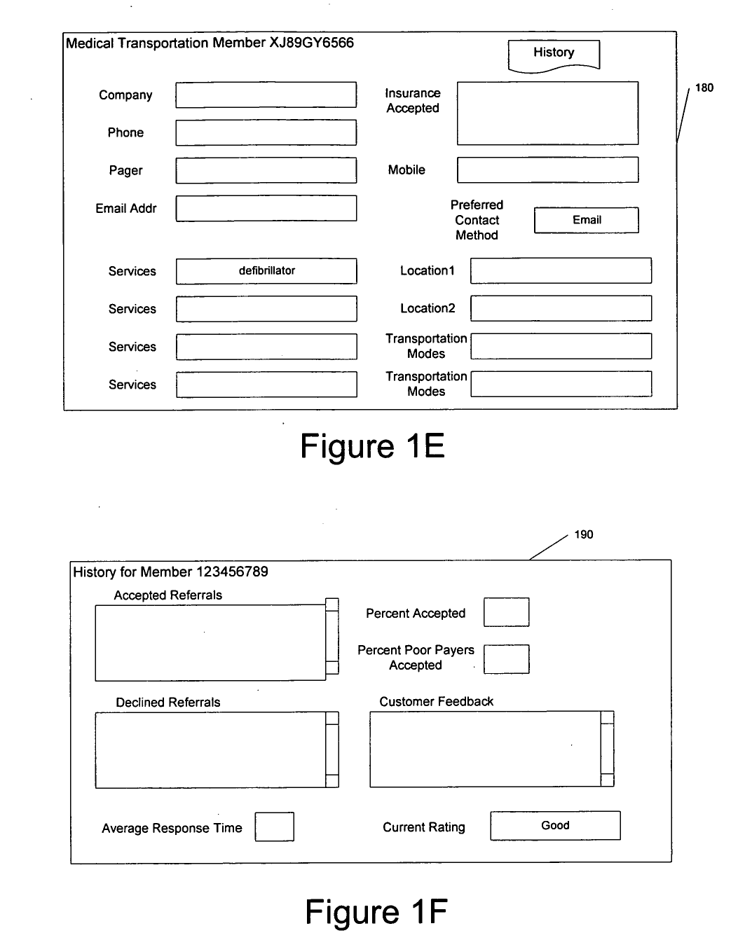

FIG. 1A is an exemplary representation of a referral and transfer management system. Referral system 109 is coupled to internet 101. Also coupled to the internet 101 may be referring providers 103, medical transportation service providers 105, and specialists 107.

FIG. 1B is an exemplary representation of referral and transfer system 109. Referral system 109 includes membership module 152, request module 154, notification module 156, and response module 158. Membership module 152 may store the profiles of all members. Members may include subscribers made up of specialist, referring providers, and medical transportation service providers. Specialists may be physicians that have a specialty such as pulmonary/respiratory specialists, neurologists, cardiologists, or various subspecialty surgeons. Referring providers may be physicians that are a first line of help such as emergency room physicians, primary care physicians, or nurse practitioners. Referring providers may be generalists and may not have the expertise on staff, the equipment, or the support for the treatment that the patient under their care needs. Medical transportation services providers may be transportation services that may support various levels of medical care during transportation, such as oxygen tents, monitors, defibrillators, and cardiovascular assist devices. Medical transportation services also may support air, water, and ground travel.

The membership module may provide for each member to store a profile. FIG. 1C is an exemplary representation of a referring provider profile screen 160. A referring provider profile may include contact information, organization and a history page link. The referring provider history may include the referrals created and dispersed. The history may offer sorting features to allow the referring provider to view the referrers by date, by specialist who accepted, or by health issue. Each referring provider member may have an identification number.

In some embodiments referral and transfer system 109 may include a real time communication module (not shown) configured to allow the referring provider, specialist and/or medical transportation services provider to communicate in real time regarding the request. In some examples, “real time” may refer to instant, near-instant, or substantially instant-type messaging that enables users to send electronic messages in a rapid fashion between computers, desktops, laptops, personal digital assistants, mobile phones, mobile data devices, and other communication devices in addition those described above. By using instant messaging or real time communication, the referring provider, specialist, and/or medical transportation services provider may transfer information (e.g., electronic patient encounter form (EPEF), patient data, medical images and documents, opinions, changes in status and the like) rapidly eliminating delays, increasing efficiency, decreasing costs, and improving accuracy in patient referrals and transfers.

FIG. 1D is an exemplary representation of a specialist profile or properties screen 170. For example, specialists profile may include contact information, area of specialty, affiliated facilities/organizations, preferred method of notification, and a history link. The history link for the specialists may include tracking information such as the ratio of referrals accepted, the ratio of referrals awarded, and the response time to reviewing urgent referrals.

In some embodiments, the history link of the referring provider and specialist also tracks compliance with the Emergency Medical Treatment and Active Labor Act (EMTALA). EMTALA promotes patient referrals and transfers. For example, a patient referral cannot be refused simply because they cannot pay. Similarly, a patient cannot be referred or transferred simply because they cannot pay. The history link may provide statistical data indicative of a trend of non-compliance with the EMTALA.

FIG. 1E is an exemplary representation of a medical transportation services provider profile 180. A medical transportation services provider profile may include contact information, locations, medical services available, modes of transportation, a preferred method of notification, and a history link. The history link of the medical transportation services provider may include tracking information such as the ratio of referrals accepted, the ratio of referrals awarded, and the response time to reviewing urgent referrals.

FIG. 1F is an exemplary representation of a history tracking screen 190. History tracking, for a specialist for example, may include a list of accepted referrals, a list of declined referrals, the ration of accepted referrals, the ratio of poor payers accepted, the average response time, and a list of patient feedback concerning the treatment or referral process. In some embodiments, a current rating may be included. The current rating may be based on one or more of the response time, the ratio of accepted, the ratio of poor payers accepted, and customer feedback.

The request module 154 may be configured to allow a referring provider to locate an appropriate specialist and initiate a request for transfer and/or referral. That is, to transfer the patient from the referring provider to the specialist. Notification module 156 may be configured to notify specialists of a new or active referral.

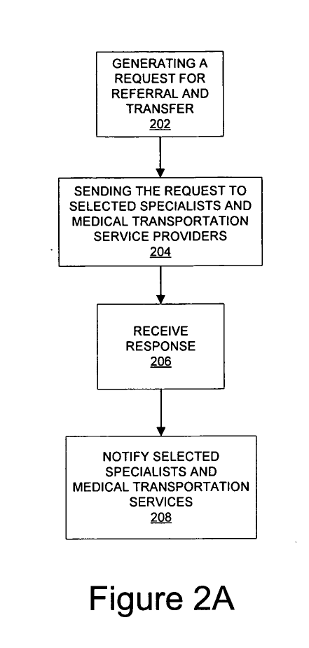

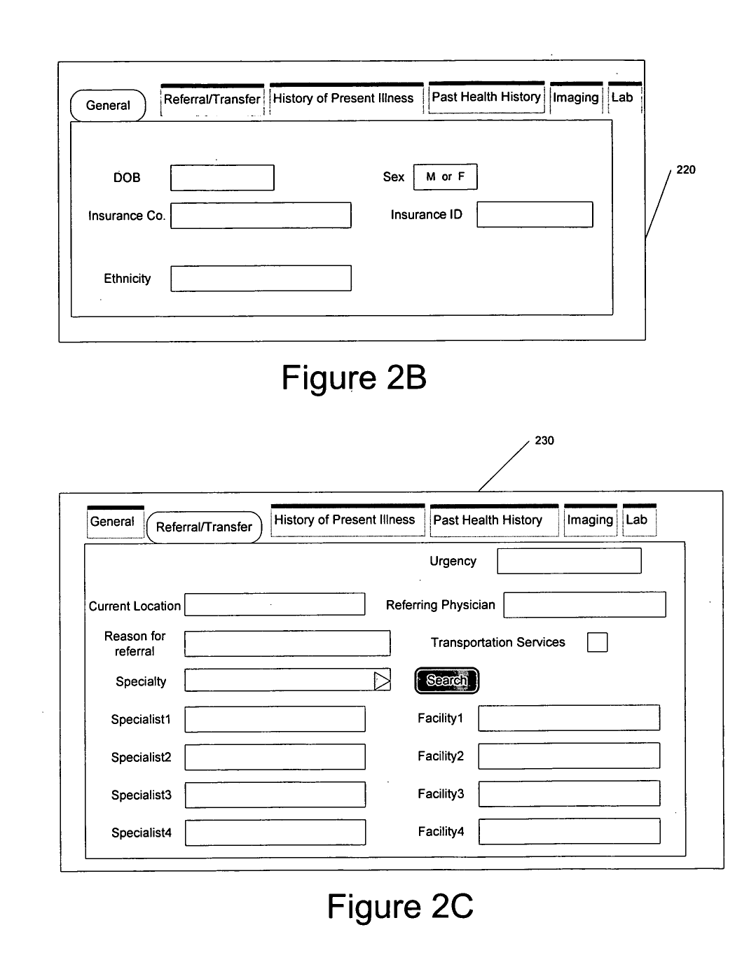

FIG. 2A is an exemplary representation of one embodiment of a method of patient referral and transfer using referral and transport system 109. In process action 202, a request may be generated for the referral and transport. The request may include pertinent information and other information, identifying one or more specialists and one or more medical transportation service providers. In process action 204, the request may be sent to the one or more specialists and the one or more medical transportation service providers via a network. In process action 206, a response may be received from the one or more specialist and the one or more medical transportation service providers that were identified in the request. The response may be used to select the one or more specialists and the one or more medical transportation service providers for receiving the referral. In process action 208, a selected specialist and a selected medical transportation service may be notified to receive the referral and transfer. The selection of the specialist and the medical transportation service being based on information included in the response.

In some embodiments, a user name and password may be required prior to generating the request. In some embodiments information included in the referral request may come from a Health Level 7 (HL7) compatible system. For example, diagnosis, lab results, x-rays, and portions of an electronic medical record may be copied and pasted or automatically populated into the referral request. Some information may be manually entered into the referral request.

In some embodiments, there may be a set of minimum information to be included in the request prior to the request for transfer and/or referral being accepted into referral system 109. Once the referral request is accepted a referral request identification (RID) number may be issued. This RID number may be used to access the referral record. In some embodiments only those requested for referral and the referring provider can view the referral record. The request notification may be sent by one or more of several communication methods, such as but not limited to, email, voicemail, pager, personal digital assistant, and mobile phone. In some embodiments, the notification may be sent by a preferred method of communication configured in the member profile.

Information in the referral request helps the specialists determine whether they can accept a request for referral. In some embodiments, the referral request information may be categorized into separate pages of information. For example, the referral request information may be categorized into general demographic information, referral information, history of present illness, past health history, imaging information, and lab information. In other embodiments, the information may be organized differently. FIG. 2B is an exemplary representation of an embodiment of general information page 220 of a referral and transfer request. The general information page may include information such as date of birth, insurance company, insurance identification number, ethnicity, etc. In some embodiments, if the patient permission has been obtained in compliance with the Health Insurance Portability and Accountability Act (HIPAA), the referral and transfer request may include the patient identifying information such as first and last name.

FIG. 2C is an exemplary representation of an embodiment of referral and transfer information page 230 of a referral and transfer request. Referral and transfer information may include the referring physician, the current location, the reason for referral, the specialization area needed, the urgency of the referral, the specialists selected, and an indication of whether medical transportation services are required. In some embodiments, the referring provider may perform a search such that a list of specialists that meet the search criteria may be located and selected for this particular referral. The marking or checking of the medical transportation service box may append a medical transportation selection page to the referral request in which member medical transportation service providers can be searched and selected for the referral and transfer request. The search for medical transportation service providers may include mode of transportation and medical care supported.

The history of present illness may include further information about the patient's present condition, tests performed, treatments begun, complications, and/or other pertinent information.

The past health history may include information about chronic conditions, previous incidents, hospitalizations, current medications, and reactions to medications.

The imaging pages may include images taken of the patient. The lab pages may include the tests performed on the patient pertaining to the current condition and the test results. In some embodiments the images and lab information may be copied and pasted or automatically populated from an HL7 compatible system.

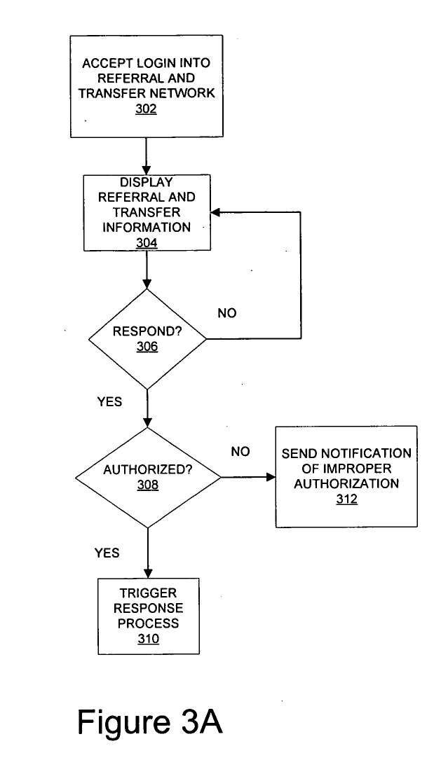

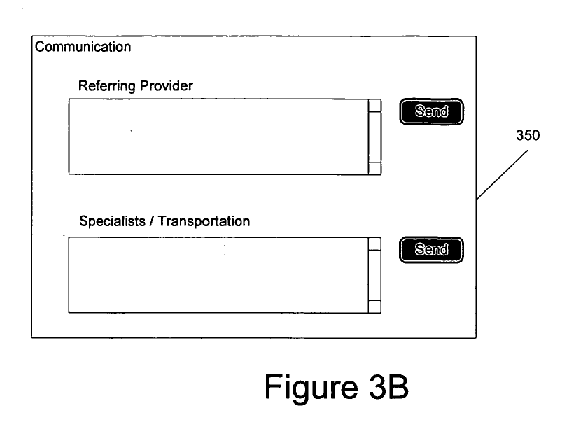

The specialist may login to the referral system to review the referral and transfer request. FIG. 3A is an exemplary representation of the referral and transfer request review process. In process action 302 a login is accepted into the referral and transfer system. During the login process the specialist may enter a username and password. In some embodiments, a list of referral and transfer requests may be displayed upon login. The specialist may select a referral and transfer request from the list for review. The referral and transfer request maybe displayed for review in process action 304. Process action 306 may determine if a response has been received for the referral and transfer request. If the referral and transfer request has not been responded to, no action is taken; the referral and transfer request continues to be displayed. If a response has been received, process action 308 may determine if appropriate authentication has been met for referral and transfer response. If improper authentication exists, a notice of improper authentication may be sent in process action 312. If the response is authorized, the response process may be triggered in process action 310. In some embodiments, the authentication of the response is assumed based on the login.

In some embodiments, the referring provider may communicate with the specialists or medical transportation service provider in a real time chat environment to discuss details about the referral and transfer request. In some examples, “real time” may refer to instant, near-instant, or substantially instant-type messaging that enables users to send electronic messages in a rapid fashion between computers, desktops, laptops, personal digital assistants, mobile phones, mobile data devices, and other communication devices in addition those described above. By using instant messaging or real time communication, the referring provider, specialist, and/or medical transportation services provider may transfer information (e.g., electronic patient encounter form (EPEF), patient data, medical images and documents, opinions, changes in status, and the like) rapidly eliminating delays, increasing efficiency, decreasing costs, and improving accuracy in patient referrals and transfers.

FIG. 3B is an exemplary representation of communication screen 350 that may provide instant communication between the referring provider and the specialist or the medical transportation services provider. The communication screen may include a text entering box for the referring provider and a text entering box for the specialist and/or medical transportation services provider. The referring provider and specialist or medical transportation services provider may be logged on to the referral and transfer system simultaneously to communicate via the communication screen 350.

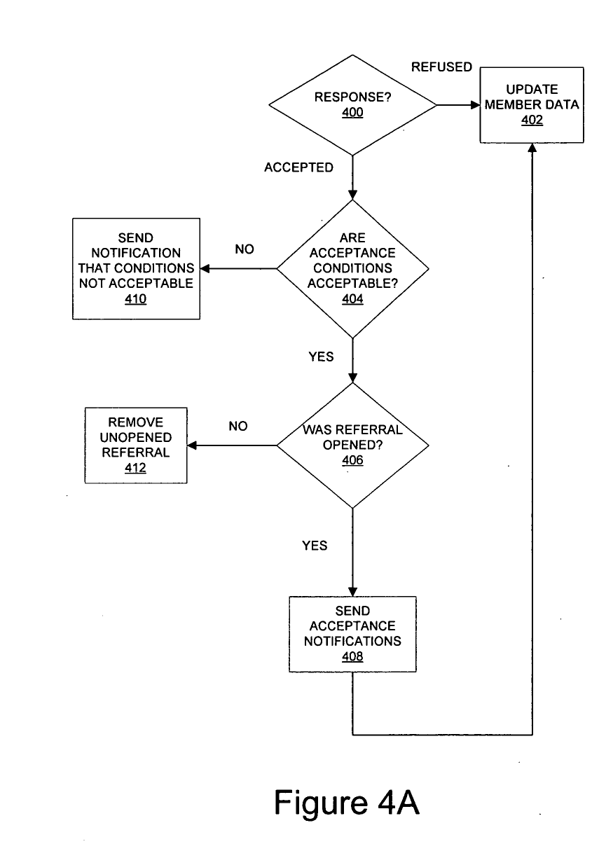

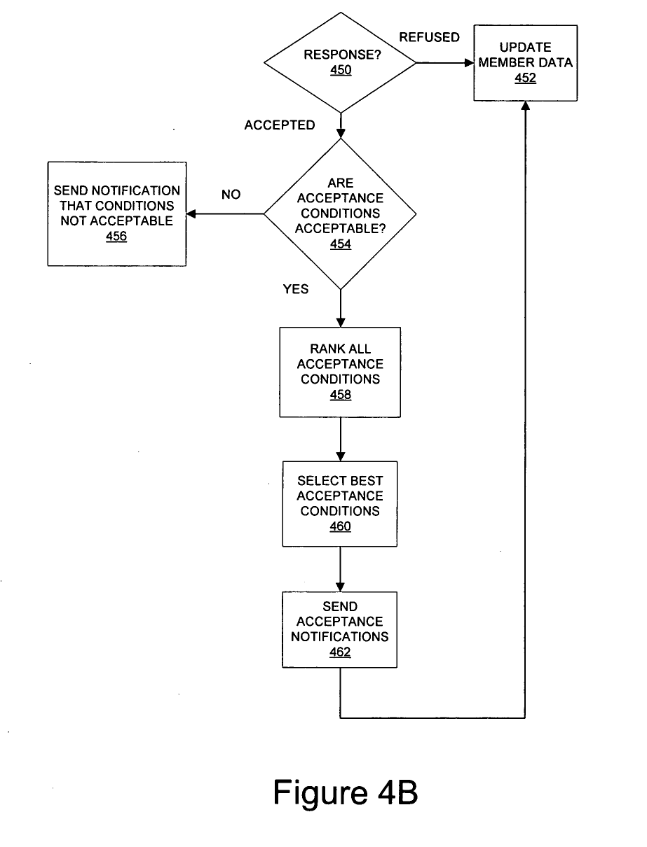

FIGS. 4A and 4B are exemplary representations of embodiments of the referral and transfer fulfillment process and are triggered upon a response to the referral and transfer request. FIG. 4A illustrates an embodiment in which the first specialist to accept the referral and transfer request is selected to receive or is awarded the referral and transfer. Process action 400 may determine the response to the referral and transfer request. If the response is to deny or refuse the referral and transfer request, process action 402 may update the member tracking history to reflect the refusal. If the response is to accept the referral and transfer request, process action 404 may determine if the acceptance conditions meet a minimum set of criteria. If the acceptance conditions do not meet a minimum set of criteria, the accepting specialist/medical transportation service provider may be notified of such in process action 410. If the set of criteria is met, process action 406 may determine if the remaining selected member specialists/medical transportation service providers have reviewed the referral and transfer request. The referral and transfer request listing may be removed from the member accounts of the other referred specialists/medical transportation service providers in process action 412 if the referral and transfer request has not been opened or reviewed by that specialist or medical transportation service provider. A notification that the referral and transfer request has been accepted and awarded may be sent to a specialist/medical transportation service provider in process action 408, if the referral and transfer request has been opened or reviewed by that specialist/medical transportation service provider. The process may return to process action 402 to allow the tracking statistics of the selected or awarded member to be updated. In some embodiments, the referring provider can select or configure the minimum acceptable criteria.

FIG. 4B illustrates an embodiment in which multiple acceptances are compared. Process action 452 determines the referral and transfer request response. If the referral and transfer request response is refusal, process action 452 updates the member tracking statistics to reflect the refusal. If the referral and transfer request response is acceptance, process action 454 may determine if the acceptance conditions meet a minimum set of criteria. If the acceptance conditions do not meet a minimum set of criteria, a notification of such may be sent to the accepting specialist in process action 456. If the acceptance conditions meet the minimum set of criteria, process action 458 may rank the acceptance conditions of all the referral and transfer request accepted responses. Process action 460 may select one of the referral and transfer request acceptances and award the referral and transfer request to that specialist. In some embodiments, the referring provider can select or configure the minimum acceptable criteria and/or the ranking criteria. In process action 462 the referral and transfer request acceptance and award notifications are sent. The process may return to process action 452 to update the member statistical data to reflect the acceptances and awards of the current referral.

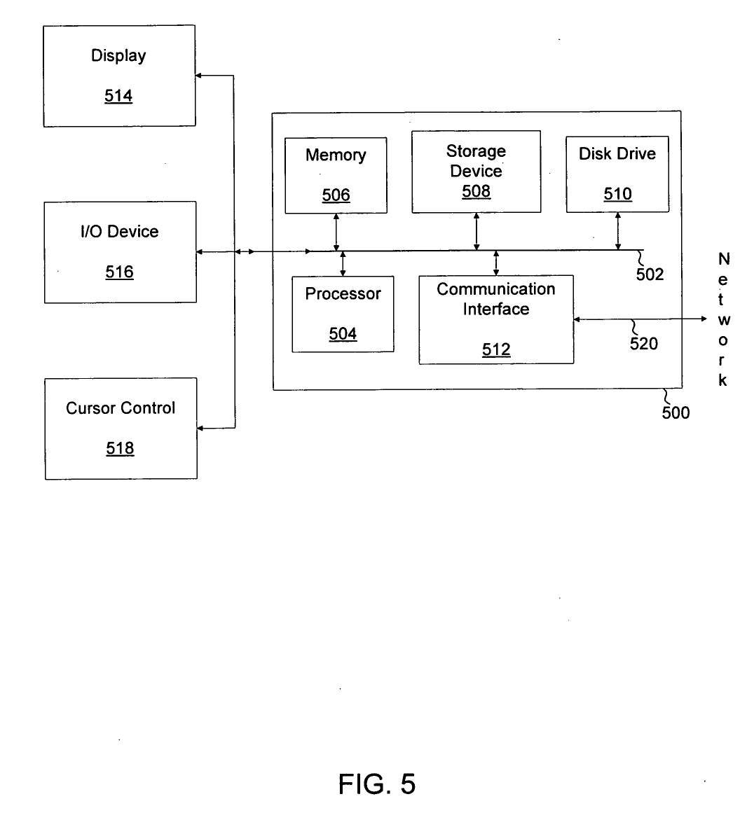

FIG. 5 is a block diagram illustrating an exemplary computer system suitable for managing a referral and a transfer, in accordance with an embodiment. In some embodiments, computer system 500 may be used to implement computer programs, applications, methods, or other software to perform the above-described techniques for fabricating storage systems such as those described above. Computer system 500 includes a bus 502 or other communication mechanism for communicating information, which interconnects subsystems and devices, such as processor 504, system memory 506 (e.g., RAM), storage device 508 (e.g., ROM), disk drive 510 (e.g., magnetic or optical), communication interface 512 (e.g., modem or Ethernet card), display 514 (e.g., CRT or LCD), input device 516 (e.g., keyboard), and cursor control 518 (e.g., mouse or trackball).

According to some embodiments of the invention, computer system 500 performs specific operations by processor 504 executing one or more sequences of one or more instructions stored in system memory 506. Such instructions may be read into system memory 506 from another computer readable medium, such as static storage device 508 or disk drive 510. In some embodiments, hard-wired circuitry may be used in place of or in combination with software instructions to implement the invention.

The term “computer readable medium” refers to any medium that participates in providing instructions to processor 504 for execution. Such a medium may take many forms, including but not limited to, non-volatile media, volatile media, and transmission media. Non-volatile media includes, for example, optical or magnetic disks, such as disk drive 510. Volatile media includes dynamic memory, such as system memory 506. Transmission media includes coaxial cables, copper wire, and fiber optics, including wires that comprise bus 502. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some embodiments of the invention, execution of the sequences of instructions to practice the invention is performed by a single computer system 500. According to some embodiments of the invention, two or more computer systems 500 coupled by communication link 520 (e.g., LAN, PSTN, or wireless network) may perform the sequence of instructions to practice the invention in coordination with one another. Computer system 500 may transmit and receive messages, data, and instructions, including program, i.e., application code, through communication link 520 and communication interface 512. Received program code may be executed by processor 504 as it is received, and/or stored in disk drive 510, or other non-volatile storage for later execution.

Although the foregoing embodiments have been described in some detail for purposes of clarity of understanding, implementations of the above-described system and techniques is not limited to the details provided. There are many alternative implementations and the disclosed embodiments are illustrative and not restrictive.

What is claimed is:

1. A method for managing a referral and a transfer, the method comprising:
generating a request for the referral and the transfer, the request including information identifying one or more specialists and one or more medical transportation service providers;
sending the request to the one or more specialists and the one or more medical transportation service providers via a network;
receiving a response from the one or more specialists and the one or more medical transportation service providers identified in the request, the response being used to select the one or more specialists and the one or more medical transportation service providers for awarding of the referral and the transfer; and
notifying a selected specialist and a selected medical transportation service to receive the referral and the transfer, the selected specialist and the selected medical transportation service being determined based on information included in the response.

2. The method of claim 1, wherein the request comprises an urgency rating.

3. The method of claim 1, wherein sending the request comprises:
determining a contact method configured in a profile; and
sending the notification via the configured contact method.

4. The method of claim 1, wherein the response includes a denial of the request.

5. The method of claim 1, further comprising communicating with the identified specialist via a chat room.

6. The method of claim 1 wherein the response includes an acceptance of the request and acceptance conditions, and the selection decision is based on the acceptance conditions.

7. The method of claim 6, wherein the selection decision is based on a fastest time to transfer.

8. The method of claim 6, wherein the selection decision is based on a facility outcome rating.

9. The method of claim 1, further comprising tracking an acceptance ratio for each of the one or more specialists.

10. The method of claim 1, further comprising tracking a selection ratio for each of the one or more specialists.

11. The method of claim 1, further comprising tracking an average response time for each of the one or more specialists.

12. The method of claim 1, wherein the request for the referral and the transfer is generated from a first organization and the response is generated from a second organization.

13. The method of claim 1, further comprising tracking an acceptance ratio for each of the one or more medical transportation service providers.

14. The method of claim 1, further comprising tracking a selected ratio for each of the one or more medical transportation service providers.

15. The method of claim 1, further comprising tracking an average response time for each of the one or more medical transportation service providers.

16. A computer system for managing referral and transfer requests, the system comprising:
membership module configured to electronically store member properties and services, wherein the membership includes a plurality of referring providers, a plurality of specialists, and a plurality of medical transportation service providers;
request module configured to originate a referral request;
notification module configured to notify members of referrals; and
response module configured to manage responses to the referral request.

17. The system of claim 16, further comprising a chat module configured to provide substantially instant messaging communication.

18. The system of claim 16 wherein the notification module is configured to notify members of a referral via email.

19. The system of claim 16, wherein the notification module is configured to notify members of a referral via pager.

20. The system of claim 16, wherein the notification module is configured to notify members of a referral via voicemail.

21. The system of claim 16, wherein the response module is configured to authenticate a response to accept the request.

22. The system of claim 16 wherein the response module is configured to compare a first response to accept the request to a second response to accept the request.

23. The system of claim 22, wherein the response module is configured to select one of the responses to accept the request based on a set of acceptance conditions included in the first and second responses.

24. The system of claim 23, wherein the selection is based on earliest admittance.

25. The system of claim 23, where in the selection is based an outcome rating of a facility.

26. The system of claim 16, wherein the request originates at a first organization and the response to the request originates at a second organization.

27. The system of claim 16, wherein the response module is configured to track a ratio of responses to accept for each member.

28. The system of claim 16, wherein the response module is configured to track an average time to response for each member.

29. The system of claim 16, wherein the response module is configured to track a ratio of selection to acceptance responses.

30. A computer program product embodied on computer readable medium, the computer readable medium having stored thereon a sequence of instructions which, when executed by a processor, causes the processor to execute a method for managing a referral and a transfer, the method comprising:
generating a request for the referral and the transfer, the request including information identifying one or more specialists and one or more medical transportation service providers;
sending the request to the one or more specialists and the one or more medical transportation service providers via a network;
receiving a response from the one or more specialists and the one or more medical transportation service providers identified in the request, the response being used to select the one or more specialists and the one or more medical transportation service providers for awarding of the referral; and
notifying a selected specialist and a selected medical transportation service to receive the referral, the selected specialist and the selected medical transportation service being determined based on information included in the response.
